(19) United States
(12) Patent Application Publication
(10) Pub. No.: US 2015/0310378 A1
(43) Pub. Date: Oct. 29, 2015

(54) System Interfacing a Fleet Management System and a Ride Sharing System

(71) Applicant: Ilan VAN DER BERG, Netanya (IL)

(72) Inventor: Ilan VAN DER BERG, Netanya (IL)

(21) Appl. No.: 14/262,751

(22) Filed: Apr. 27, 2014

(51) Int. Cl. G06Q 10/06; G06Q 50/30

(52) U.S. Cl. CPC G06Q 10/063114; G06Q 50/30

(57) ABSTRACT

A system associated with a fleet management system and in networked communications with a ride sharing system. A computing device derives from a fleet management system potential ride offers. The potential ride offers are sent to a ride sharing system. The computing device receives from the ride sharing system ride requests corresponding to the potential ride offers. Ride events are created or updated according to the ride requests and ride offers. The users of the ride sharing system (e.g. passengers) may request data from the fleet management system pertaining to the ride vehicle. The computing device filters proprietary fleet management system information prior to sending the requested data to the passengers. In another embodiment, the computing device opens an identity-masked channel of communication for ride coordination between fleet vehicle drivers and passengers.

### FIELD AND BACKGROUND OF THE INVENTION

The application relates to ride coordination between fleet management systems and ride sharing systems. More specifically, the present invention relates to scheduling and routing, in real time, fleet vehicle and passenger transportation.

It is known that ride matching systems based on passenger and driver information require levels of information sharing between the parties involved. Ride coordination between freight vehicles and passengers is also known, but the freight information is unprotected and communication between the freight vehicles and the passengers is limited.

There is therefore a need for to provide a system which allows coordination between fleet vehicles and ride sharing passengers for ride scheduling and routing where the fleet information is filtered and protected from the ride sharing passengers. There is also a need for a system to provide communication between drivers of the fleet vehicles and ride sharing passengers where the identities of the parties involved are masked.

### SUMMARY OF THE INVENTION

The present invention is a fleet management system interfaced with a ride sharing system, providing coordination of rides between ride sharing system users and fleet management vehicles.

According to the teachings of the present invention there is provided, a system associated with a fleet management system and in networked communications with a ride sharing system.

In one embodiment, a computing device associated with a fleet management system and in networked communications with a ride sharing system may be configured to derive from the fleet management system a plurality of potential ride offers and communicate said potential ride offers to the ride sharing system, receive from the ride sharing system ride requests corresponding to said potential ride offers, create or update corresponding fleet management events for implementation of rides associated with said ride offers and said ride requests, and transmit to said fleet management system data requests derived from said ride sharing system and communicate filtered data responses to said data requests.

In another embodiment, said data requests and said filtered data responses may be identity-masked communications for ride coordination between a driver of a vehicle associated with said fleet management system and a passenger of said ride.

In another embodiment, said computing device may be further configured to process data in real-time derived from said fleet management system for scheduling changes to said rides and transmit to said ride sharing system updated data associated with said rides.

In another embodiment, said computing device may be further configured to apply a set of logic rules to said potential ride offers and to said ride requests to determine commercial viability and price.

In another embodiment, said price may be tiered to reflect high priority passengers.

In another embodiment, said ride offers may be created based on a time window of availability for providing said rides.

In another embodiment, said ride offers may be created based on a location window of availability for providing said rides.

In another embodiment, a computing device associated with a fleet management system and in networked communications with a ride sharing system may be configured to derive from the fleet management system a plurality of potential ride offers and communicate said potential ride offers to the ride sharing system, receive from the ride sharing system ride requests corresponding to said potential ride offers, create or update corresponding fleet management events for implementation of rides associated with said ride offers and said ride requests, and selectively open an identity-masked channel of communication for ride coordination between a driver of a vehicle associated with said fleet management system ride and a passenger of said ride.

The above represents only exemplary embodiments of the invention and is not intended to otherwise limit the scope of the invention as claimed herein.

### BRIEF DESCRIPTION OF THE DRAWINGS

The invention is herein described, by way of example only, with reference to the accompanying drawings, wherein:

FIG. 1A illustrates a block diagram of a fleet management system interfaced with a ride sharing system according to one exemplary embodiment of the invention;

FIGS. 1B and 1C illustrate a block diagram of a fleet management system according to one exemplary embodiment of the invention;

FIG. 1D illustrates an example of communication in a fleet management system;

FIG. 2 illustrates a process for ride coordination between a fleet management system and a ride sharing system according to one exemplary embodiment of the invention.

### DESCRIPTION OF THE PREFERRED EMBODIMENTS

The present invention is a fleet management system interfaced with a ride sharing system, providing coordination of rides between ride sharing system users and fleet management vehicles.

The principles and operation of a fleet management system interfaced with a ride sharing system, providing coordination of rides between ride sharing system users and fleet management vehicles according to the present invention, may be better understood with reference to the drawings and the accompanying description.

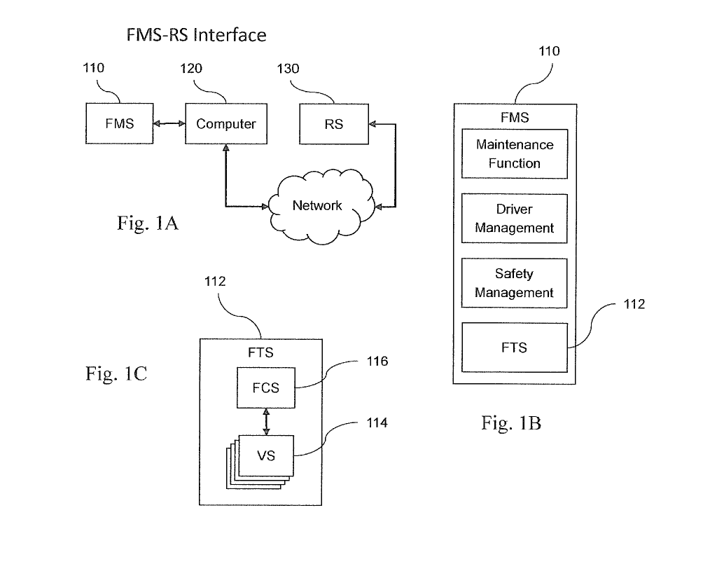

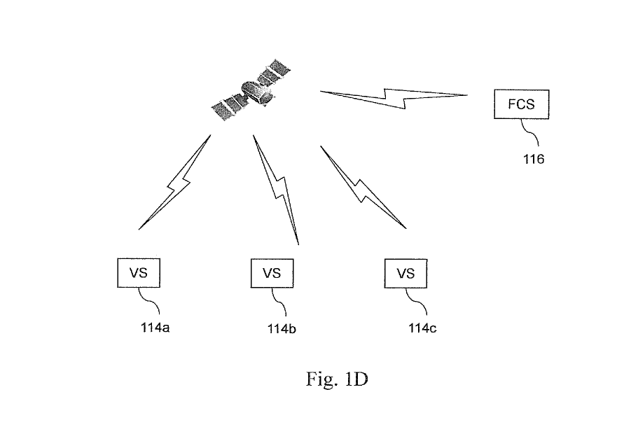

Referring now to the drawings, FIG. 1A is an overall system block diagram showing a preferred embodiment of a representative fleet management system (FMS) 110 interfaced 120 with a ride sharing (RS) system 130. The interface 120 may be a networked computing device with major elements including dedicated hardware, software, and a storage medium such as a memory. With reference to FIG. 1B, the FMS 110 may include a fleet telematics system (FTS) 112 which facilitates the exchange of information between fleet vehicles and a central authority, such as a dispatching office. The FMS 110 may also include other functionality, including, but not limited to, maintenance functions, health and safety management, and driver management. With reference to FIG. 1C, the FTS 112 may include mobile vehicle systems (VS) units 114 and a stationary fleet communication system (FCS) 116. The FCS 116 may include a database which stores data associated with fleet vehicles. Examples of data stored in the database may include, but are not limited to, vehicle position information and vehicle messages.

With reference to FIGS. 1A-D, in the preferred embodiment, a FMS 110 includes multiple fleet vehicles, each equipped with a VS unit 114. Each VS unit 114 communicates vehicle information to the FCS 116 by a communication medium. Any suitable communication medium may be used, including, but not limited to, satellite communication, cellular broadband, and trunked radio. An example of three VS units 114a,114b,114c in communication with a FCS 116 via satellite is depicted in FIG. 1D. The information communicated by a VS unit 114 to the FCS 116 may include, but is not limited to, vehicle position, vehicle speed, fuel level, and service distance. Updated information may be communicated periodically from each VS unit 114 to the FCS 116, with different information types optionally having different updated periods.

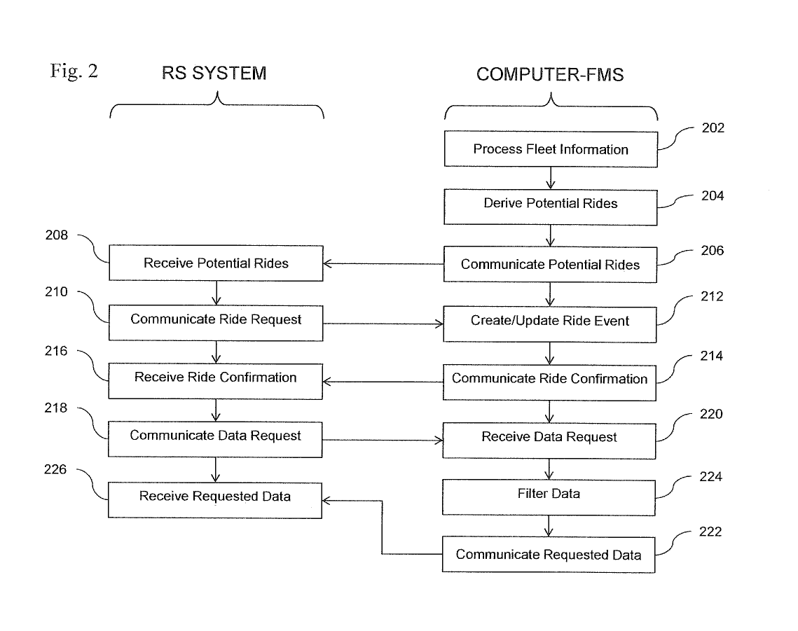

With reference to FIGS. 1A-C and FIG. 2, the processing flow of a preferred embodiment is described. A computer 120 associated with a FMS 110 and corresponding FTS 112 is configured to process information 202 received by the FCS 116 and stored in the FCS database. The computer may process the information using algorithms in software to derive potential ride offers 204. The potential ride offers are communicated 206 and received 208 by a RS system 130 by a suitable communication means, including, but not limited to, internet protocol. Users of the RS system 130 may request rides 210 corresponding to available potential ride offers. The ride requests are subsequently communicated back to the computer 120 so the FMS 110 may create an event 212 to implement a ride associated with the ride offer and ride request. Although not depicted in the figures, the route of the fleet vehicle after the addition of a passenger may be optimized with respect to the FMS such that the passenger has a minimal, or weighted, effect on the route. In the event that a user of the RS system 130 requests a ride corresponding to a potential ride offer from a vehicle already carrying a passenger associated with the RS system 130, the ride request is subsequently communicated back to the computer 120 so the FMS 1.10 may update 212 an existing event. The route may be optimized with respect to the FMS 110 such that the passengers have minimal, or weighted, effect on the route. Ride confirmation is communicated 214 from the FMS 110 and received 216 by the RS system 130.

The system may be configured such that RS system 130 users may request data 218 from the FMS 110 regarding potential ride offers or existing ride events. The data request is received 220 by the FMS 110, and prior to communicating 222 FMS 110 data to the RS system 130, the data may be filtered 224 to prevent sensitive or proprietary data from becoming available to unauthorized users. The data may also be filtered to prevent sensitive or proprietary data from becoming available based on the time or location of the user requesting the data. The filtered data is subsequently received 226 by the RS system 130. Types of data which may be considered proprietary may include, but are not limited to, real-time geographic location of all fleet vehicles, vehicle cargo information, and fleet customer information. For example, if a user is waiting for a scheduled pickup from a fleet vehicle, the user may request to see the current location of the vehicle. The interface 120 may be configured to prevent the user from receiving the precise location of the vehicle until the vehicle is within a certain distance from the scheduled pickup location or within a few minutes of the scheduled pickup time. The interface 120 may also be configured to translate all vehicle location requests from users into an estimated time of arrival.

The data filtering may also be used to mask the identity of drivers and confirmed passengers in order to securely facilitate the coordination of passenger pick-up and drop-off. Types of identity-masked communication may include, but are not limited to, short message service (SMS), multimedia messaging service (MMS), smartphone chat applications, Voice over IP (VoIP), and voice communication via a telephone system. One example of an identity-masked telephone call may be a conference call initiated by the interface 120. Another example of an identity-masked telephone call may be a direct phone call between the vehicle driver and the passenger wherein the driver phone number is not visible to the passenger. Identity-masked channels based on messaging services may be directed via a central communications hub or otherwise configured to mask the phone number of the driver via spoofing or other appropriate techniques.

In another embodiment, the computer 120 of FIG. 1A may further include a real-time operating system in order to facilitate real-time processing. The computer may process, in real-time, data derived from the FMS for transmission to the RS system. The data derived from the FMS may include changes to scheduling data including, but not limited to, estimated time of arrival, passenger pick-up location, route updates, and pick-up cancellations.

In another embodiment, subsequent to matching ride requests with corresponding potential ride offers, a set of logic rules may be applied in order to determine an appropriate price each passenger must pay for the ride. A set of logic rules may also be applied to determine the commercial viability of a potential ride match. For example, if a potential ride is matched between a passenger and a vehicle, the system may determine that the vehicle must significantly increase the distance of its route to accommodate the passenger ride request, thus deeming the route not commercially viable. The FMS may have the option of rejecting the ride match in cases of low commercial viability, and/or requesting a higher price. Furthermore, if a passenger deems that the price for a potential ride match is too expensive, the passenger may reject the ride match through the RS system, or request a lower price.

In another embodiment, the computer may be configured to selectively open a channel of communication between drivers and confirmed passengers in which the identities of the drivers and the passengers are masked in order to securely facilitate the coordination of passenger pick-up and drop-off Types of identity-masked communication may include, but are not limited to, short message service (SMS), multimedia messaging service (MMS), smartphone chat applications, Voice over IP (VoIP), and voice communication via a telephone system. One example of an identity-masked telephone call may be a conference call initiated by the interface 120. Another example of an identity-masked telephone call may be a direct phone call between the vehicle driver and the passenger wherein the driver phone number is not visible to the passenger. Identity-masked channels based on messaging services may be directed via a central communications hub or otherwise configured to mask the phone number of the driver via spoofing or other appropriate techniques. In another embodiment, users of the RS system may be registered as premium users at a potentially added cost. Premium users may be entitled to higher priority ride service.

In another embodiment, the potential ride offers may be derived from a reduced FMS data set in order to create rides that operate at a specific time of day. This enables users of a RS system to request rides for a specific time of day.

In another embodiment, the potential ride offers may be derived from a reduced FMS data set in order to create rides that operate in a specific geographic location. This enables users of a RS system to request rides within a specific geographic area.

In another embodiment, the interface 120 and the RS system 130 may be in communication via a cloud server. The interface 120 may upload portions or all of the data derived from the FMS 110 to a cloud server. The RS system 130 may subsequently download portions or all of the corresponding data from the cloud server. The RS system 130 may also upload portions or all data to a cloud server. The interface 120 may subsequently download portions or all of the corresponding data from the cloud server.

In another embodiment, the hardware of the interface 120 may be integrated as part of the FMS 130.

In all respects other than those described, the structure and function of the FMS 110 and the RS system 130 may be implemented according to standard practices as is well known in the art, and according to various examples commercially available.

It will be appreciated that the above descriptions are intended only to serve as examples, and that many other embodiments are possible within the scope of the present invention as defined in the appended claims.

What is claimed is:

1. A system associated with a fleet management system and in networked communications with a ride sharing system, the system comprising:
(a) a computing device comprising at least one processor and a data storage medium,
wherein said computing device is configured to:
(i) derive from the fleet management system a plurality of potential ride offers and communicate said potential ride offers to the ride sharing system;
(ii) receive from the ride sharing system ride requests corresponding to said potential ride offers;
(iii) create or update corresponding fleet management events for implementation of rides associated with said ride offers and said ride requests; and
(iv) transmit to said fleet management system data requests derived from said ride sharing system and communicate filtered data responses to said data requests.

2. The system of claim 1, wherein said data requests and said filtered data responses are identity-masked communications for ride coordination between a driver of a vehicle associated with said fleet management system and a passenger of said ride.

3. The system of claim 2, wherein said computing device is further configured to process data in real-time derived from said fleet management system for scheduling changes to said rides and transmit to said ride sharing system updated data associated with said rides.

4. The system of claim 3, wherein said computing device is further configured to apply a set of logic rules to said potential ride offers and to said ride requests to determine commercial viability and price.

5. The system of claim 4, wherein said price is tiered to reflect high priority passengers.

6. The system of claim 3, wherein said ride offers are created based on a time window of availability for providing said rides.

7. The system of claim 3, wherein said ride offers are created based on a location window of availability for providing said rides.

8. A system associated with a fleet management system and in networked communications with a ride sharing system, the system comprising:
(a) a computing device comprising at least one processor and a data storage medium,
wherein said computing device is configured to:
(i) derive from the fleet management system a plurality of potential ride offers and communicate said potential ride offers to the ride sharing system;
(ii) receive from said ride sharing system ride requests corresponding to said potential ride offers;
(iii) create or update corresponding fleet management events for implementation of rides associated with said ride offers and said ride requests; and
(iv) selectively open an identity-masked channel of communication for ride coordination between a driver of a vehicle associated with said fleet management system ride and a passenger of said ride.
